(19) United States
(12) Patent Application Publication
(10) Pub. No.: US 2015/0321778 A1
(43) Pub. Date: Nov. 12, 2015

(54) Band Tensioning Tool

(71) Applicant: Band-It-IDEX, Inc., Denver, CO (US)

(72) Inventor: Miklos B. Marelin, Aurora, CO (US)

(21) Appl. No.: 14/685,330

(22) Filed: Apr. 13, 2015

Related U.S. Application Data
(60) Provisional application No. 61/990,339, filed on May 8, 2014.

(51) Int. Cl. B65B 13/34; B26D 1/547

(52) U.S. Cl. CPC B65B 13/345; B26D 1/5475

(57) ABSTRACT

A method and apparatus for securing a cable tie about an object is described. Further, a relatively compact banding tool that facilitates cable tie tensioning is described.

This application claims the benefit of U.S. Provisional Patent Application Ser. No. 61/990,339, filed May 8, 2014, the entirety of which is incorporated by reference herein.

This application is related to U.S. Pat. No. 5,566,726 and to U.S. Pat. No. 4,896,402, the entire disclosures of which is incorporated by reference herein.

This application is also related to U.S. Patent Application Publication No. 2013/0199382, the entirety of which is incorporated by reference herein.

### FIELD OF THE INVENTION

Embodiments of the present invention relate to a method and apparatus for securing a cable tie about an object, and in particular, to a relatively compact banding tool that facilitates cable tie tensioning.

### BACKGROUND OF THE INVENTION

Cable ties, which are sometimes referred to as “band clamps,” are typically used to bundle wiring, to secure back shells to cables, to secure heat shields to pipes, and secure signage to poles. Cable ties are generally comprised of a band with an interconnected head that acts as a buckle that secures a free end of the band after a predetermined tension has been achieved. Some bands have had operatively interconnected buckles or seals, instead of an integrated head, that are used to secure the band's free end.

Tensioning tools are used to tighten cable ties. For example, the tensioning tool described in U.S. Pat. No. 5,566,726, which is incorporated by reference herein, employs a band gripping mechanism (also denoted a “tension block”) that repeatedly grips and moves a portion of the band, which tensions the band about objects being banded. More specifically, to tension the band, the tension block is first moved along a length of the band in a first direction, generally toward the objects being banded. The tension block then engages the band and moves generally away from the objects being banded to incrementally tension the band. The tension block grips the band with a cylindrical pin having an axis that is oriented along the width of the band. The cylindrical pin may be biased by a spring, or other biasing device, to ensure firm engagement with the band when the tension block is pulled away from the objects being banded. After the tension block has moved its full extent away from the objects being banded, the tension block is released from the band so that it can be moved to another location on the band to begin another incremented tension cycle. When the tension block is moved, band tension is maintained by a front gripper that selectively contacts the band between the tension block and the objects being banded.

FIG. 1 shows a band tightening tool 2 of the prior art and illustrates the tensioning steps described above. More specifically, the tension block 6 and the front gripper 10 spaced therefrom. The band 14 is threaded through both the tension block 6 and the front gripper 10. The tension block 6 includes a proximal end 18 which is closer to the objects being banded 22 than a distal end 26. The dashed outline of the tension block 6 represents the movement of the proximal end 18 towards the objects 22. The tension block 6 further includes a platform 30 that supports the band 14 as it passes through the tension block 6. The tension block 6 also includes a lateral opening 34 that inclines toward the platform 30 toward the proximal end 18 of the tension block 6. The tension block 6 further includes a gripping pin (or gripper) 38 that is operatively positioned and movable within the lateral opening 34. The pin 38 is biased by a biasing member (not shown) that moves the gripping pin 38 in the direction of arrow 40 to firmly engage the band 14. When the tension block 6 moves in the direction of arrow 44, the gripping pin 38 is not biased and is able to slide on the surface of the band 12. However, when the tension block 6 is moved away from the objects 22 (i.e., in the direction of arrow 48), the gripping pin 38 moves toward a proximal end 52 of the lateral opening 34 and frictionally engages and grips the band 14.

The front gripper 10 also includes an inclined lateral opening 56 and a gripping pin 60 that moves within the opening 56. The gripping pin 60 is biased toward a proximal end 64 of the opening 56. When the tension block 6 is not tensioning the band 14, i.e., moving in the direction of arrow 44, the gripping pin 60 of the front gripper 10 frictionally engages the band 14 so that it is not slackened by a band tension counterforce acting in the direction of arrow 68. Once the tension block 6 has completed its movement toward the front gripper 10, it reverses direction, thereby causing the gripping pin 38 to securely engage the band 14 and pull it in the direction of arrow 48. Movement of the band 14 in the direction of arrow 48 causes the gripping pin 60 to disengage from the band 16, thereby allowing the band 14 to be pulled into the band tightening tool 2.

FIG. 4 shows the interconnection of the blade 70 to the tool head 74. Here, the prior art blade 70 is shown rotatably interconnected to the tool head 74 via a pin 78 that is attached to sidewalls of the tool head 74. Forces acting on the blade 70, which are generated by the knife 82, will be reacted by the 78. Forces will also be transmitted through the pin 78 to the sidewalls of the tool head, which often weakens or damages the same.

After the tension block and the front gripper perform their respective duties, the band is severed and clamped, i.e., locked to a buckle or seal. A stationary blade is provided beneath the front gripper and a movable knife is provided forward of the front gripper. The knife moves relative to the blade to sever a band located therebetween. More specifically, once the desired band tension is achieved, a linkage is used to move the knife closer to the blade which compresses the band and eventually severs the same. The gap between the knife edge and the blade edge is preferably maintained within a predetermined tolerance that will ensure bands are cut in the most effective manner, even after many cutting cycles.

One drawback of prior art tensioning tools is that downward pressure from the knife is transmitted through the band and to the blade, which stresses the blade and adversely affects its effectiveness. Band cutting is also adversely affected because the blade edge is spaced from the blade's attachment point, i.e., the location where pressure acting on the blade's cutting edge is reacted. Over time, the blade may be prone to flex, which can lead to fatigue and ultimately failure.

One of ordinary skill in the art will appreciate that cutting will eventually weaken the blade and cause it to yield or fracture. Unfortunately, the failure rate and mode is unpredictable, wherein the blade may fail after 100, 200, or 1000 bands are tensioned. When blades fail, the tools are shipped from the end user to the factory for blade or knife replacement, which is expensive, costly, and time consuming.

As alluded to above, blade support of prior art tools is not ideal and blade damage is common. The primary failure mode is blade edge degradation and, in some instances, fracture. More specifically, the blade of prior art tools is rotatably interconnected to a tool head. Further, the blade of some prior art tools possesses an internal non-cutting edge that engages the tool head to react loads generated at an external cutting edge of the blade when the knife contacts the band positioned between the knife and the blade. This complex design came from a desire to provide a blade with two edges such that when one was damaged, the blade could be removed and rotated to locate the previously non-used blade adjacent to the knife.

Another drawback of prior art tensioning tools is that the knife does not travel in a smooth, continuous manner, thus a gap between the knife and the blade is not consistent, which affects cutting performance and can increase blade loads. For example, if the space between the knife's cutting edge and the blade's cutting edge is too wide, knife travel may be inadequate to sever the band as material will deform between the knife edge in the blade edge. If the gap is too narrow, excess loads generated by the knife will be transferred to the blade and cause damage.

In view of the foregoing, there exists a need for a banding tool that maintains tolerance between the knife and blade, which increases blade life.

### SUMMARY OF THE INVENTION

In accordance with one aspect of the invention, a band tensioning tool is provided that includes a tensioning mechanism having a first longitudinal axis therethrough. The tensioning mechanism comprises a force storing device within a tool handle. A tension adjustment plunger, a tension adjustment screw, and a connecting rod are interconnected to the force storing device and to tension transferring device. In one embodiment, the force storing device is a compression spring that is precompressed to a desired amount by the adjustment plunger.

The tension transferring device comprises a tension transfer lever interconnected to the tensioning device and a tensioning block. At least one push link is connected on a first end thereof to the tensioning device, and on a second end to a lever arm. The tension block, which has an elongated slot and a tension pin, is connected to the lever arm, wherein the tension block pulls the band into tension.

It is still yet another aspect the present invention to provide a knife with an arcuate cutting edge and a head deformation edge. More specifically, the cutting edge of one embodiment of the present invention initially contacts the band and is used with the blade to sever the band. Thereafter, the deformation edge of the knife is adapted to contact the cable tie's locking feature, e.g., the cable tie head, and deforms the same. Deforming the head will change its geometry and, thus, change its moment of inertia and strength. As the head is designed to maintain band tension, those of ordinary skill in the art will appreciate that increased head stiffness will maximize the cable tie's retained force. The knife of one embodiment of the present invention also removes sharp corners and provides a smooth cut, which is desirable for safety.

Tools of embodiments of the present invention are designed to tension and secure various types of band clamps and cable ties. Some versions of the contemplated tool are suited to secure cable ties commonly sold by the assignee of the instant application under the trademark Tie-Dex, which are described in U.S. Pat. No. 4,896,402. As one of skill the art will appreciate, it is often desirable to reduce cable tie weight, which can be accomplished if tie thickness is reduced. Accordingly, it is one aspect of embodiments of the present invention to provide a cable tie of reduced thickness made of tempered stainless steel. In applications where a reduced diameter banding is required, the thinner band will perform better than the current cable ties.

Existing tools often have difficulty in cutting thinner cable ties. More specifically, because of tolerance stack between the cutter knife (moving portion) and the blade (stationary portion), the gap between the two components that affect cutting may vary over time. Often, the gap will generally increase over time and the cable tie will deform instead of severing as a knife passes the blade. It is thus another aspect of the present invention to control the distance between the blade's cutting surface and the knife. By maintaining a tight tolerance between these two components, thinner bands can be formed and severed without bending.

One embodiment of the present invention achieves this goal of maintaining tight tolerances by including a blade with an integrated knife housing. The knife housing includes a channel that slidingly receives the knife. In this fashion the tolerance between the knife and the blade is maintained because the knife's movement is limited by the knife channel. The blade edge also interacts with a load point that is near the blade edge, which reduces damaging loads acting on the blade. Furthermore, by maintaining the tolerance between the knife and the blade edge, the gap between these two components can be maintained after many uses.

The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. These and other advantages will be apparent from the disclosure of the invention(s) contained herein. The above-described embodiments, objectives, and configurations are neither complete nor exhaustive. As will be appreciated, other embodiments of the invention are possible using, alone or in combination, one or more of the features set forth above or described below.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a cross sectional view showing a band tensioning device of the prior art;

FIG. 2 is a cross sectional view showing a knife and blade of the prior art;

FIG. 3 is a side elevation view of one embodiment of the present invention;

FIG. 4 is a bottom perspective view of FIG. 3;

FIG. 5 is a side elevation view opposite to that of FIG. 3;

FIG. 6 is another bottom perspective view;

FIG. 7 is a cross-sectional view of one embodiment of the present invention;

FIG. 8 is a partially exploded view of one embodiment of the present invention;

FIG. 9 is a top perspective view of one embodiment of the present invention;

FIG. 10 is a detailed view of a blade of one embodiment of the present invention;

FIG. 11 is a perspective view showing the blade and knife one embodiment of the present invention;

FIG. 12 is a perspective view of the blade of one embodiment of the present invention;

FIG. 13 is a cross-sectional view of the blade of one embodiment a present invention;

FIG. 14 is a perspective view showing the knife of one embodiment of the present invention; and

FIG. 15 is an alternative embodiment of the present invention in which the banding tool is a pneumatic device.

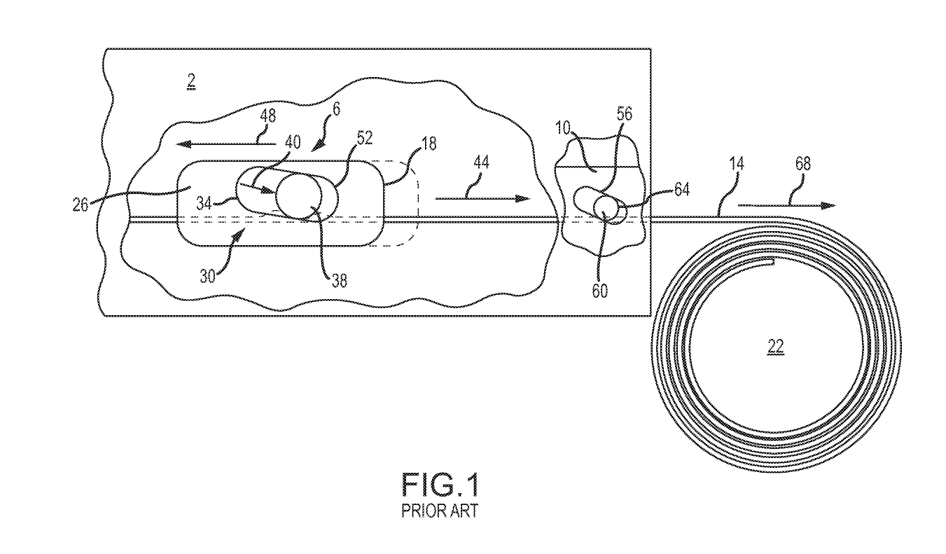

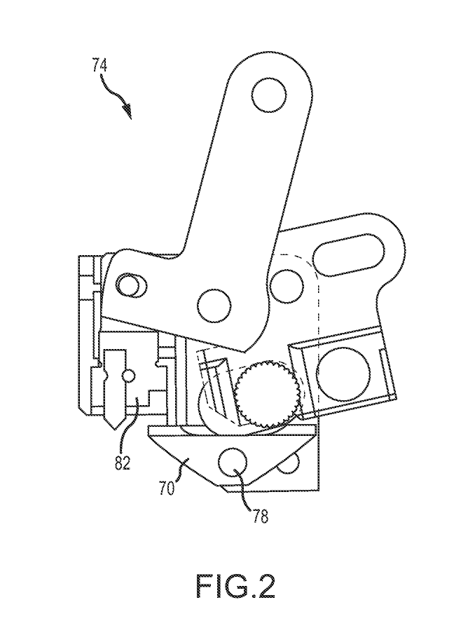

To assist in the understanding of one embodiment of the present invention the following list of components and associated numbering found in the drawings is provided herein:

| # | Component |
|---|---|
| 2 | Band tightening tool |
| 6 | Tension block |
| 10 | Front gripper |
| 14 | Band |
| 18 | Proximal end |
| 22 | Objects |
| 26 | Distal end |
| 30 | Platform |
| 34 | Lateral opening |
| 38 | Gripping pin |
| 52 | Proximal end |
| 56 | Lateral opening |
| 60 | Gripping pin |
| 64 | Proximal end |
| 70 | Blade |
| 74 | Tool head |
| 78 | Pin |
| 82 | Knife |
| 100 | Banding tool |
| 104 | Head |
| 108 | Handle |
| 112 | Tension handle |
| 116 | Cutoff handle |
| 120 | Hook |
| 124 | Blade |
| 128 | Knife |
| 132 | Front gripper |
| 136 | Spring |
| 140 | Rod |
| 144 | Transfer lever |
| 148 | Tension block |
| 152 | Gripper |
| 156 | Band |
| 160 | Cutter arm |
| 164 | Housing |
| 168 | Knife channel |
| 172 | Channel |
| 176 | Blade edge |
| 180 | Cutting Edge |
| 184 | Deformation Edge |
| 200 | Pneumatic tool |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

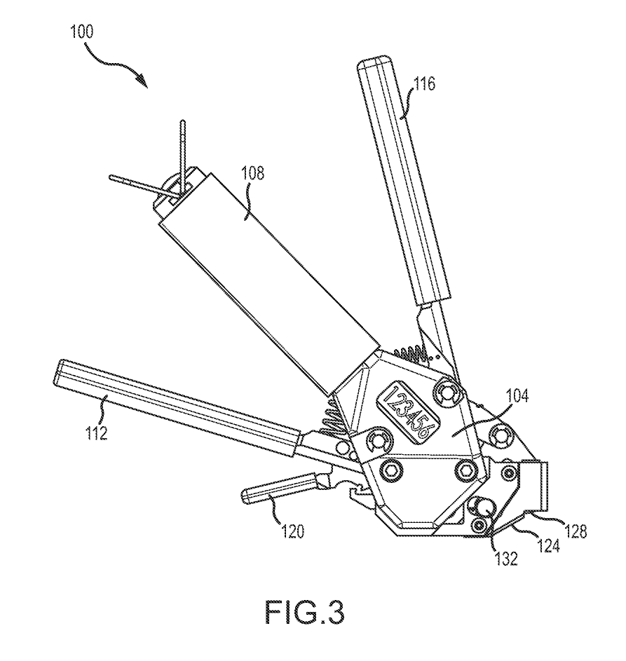

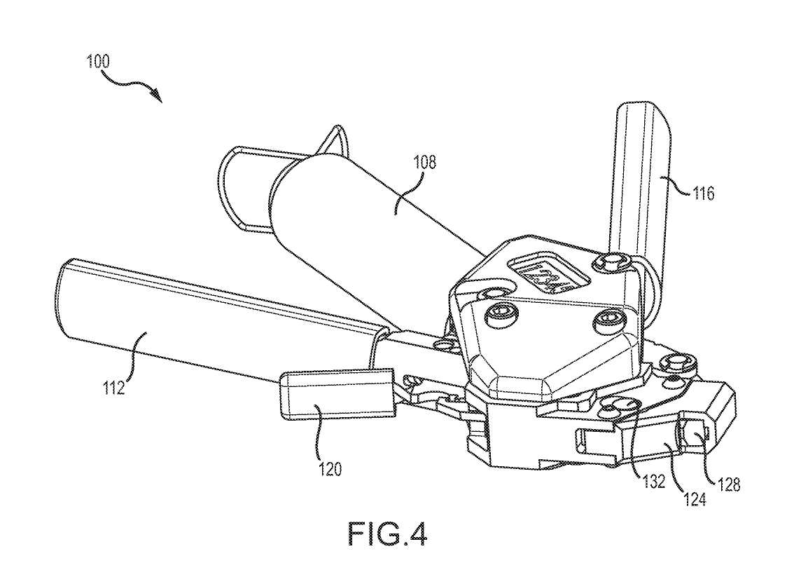

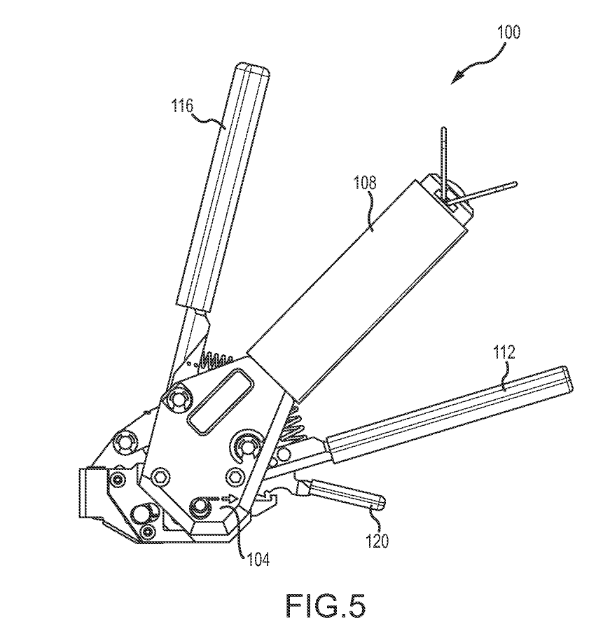

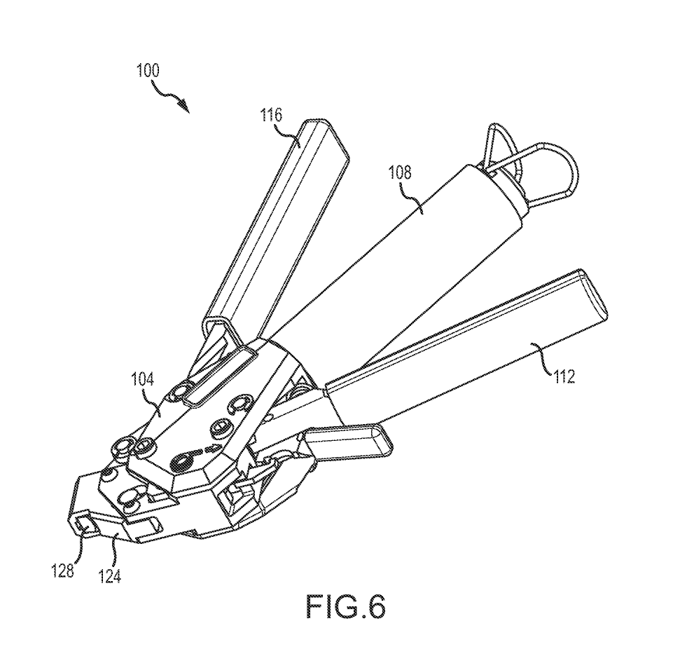

FIGS. 3-6 show a banding tool 100 of embodiments of the present invention that is designed to tension and secure a band clamp comprising a band and a band locking head. The banding tool 100 includes a head 104 interconnected to a handle 108. A tension handle 112 and a cutoff handle 116 are rotatably interconnected to the head 104 and move relative to the handle 112. A hook 120 is also rotatably interconnected to the head 104 and is adapted to fix the tension of a band inserted into the head 104. The head 104 also accommodates a blade 124 that is operatively associated with a knife 128. As in the existing banding tools, a front gripper 132 is used to tension the band by operation of the tension handle 112. The operation of this embodiment of the present invention is a very similar to that shown and described in U.S. Pat. No. 5,566,726 mentioned above.

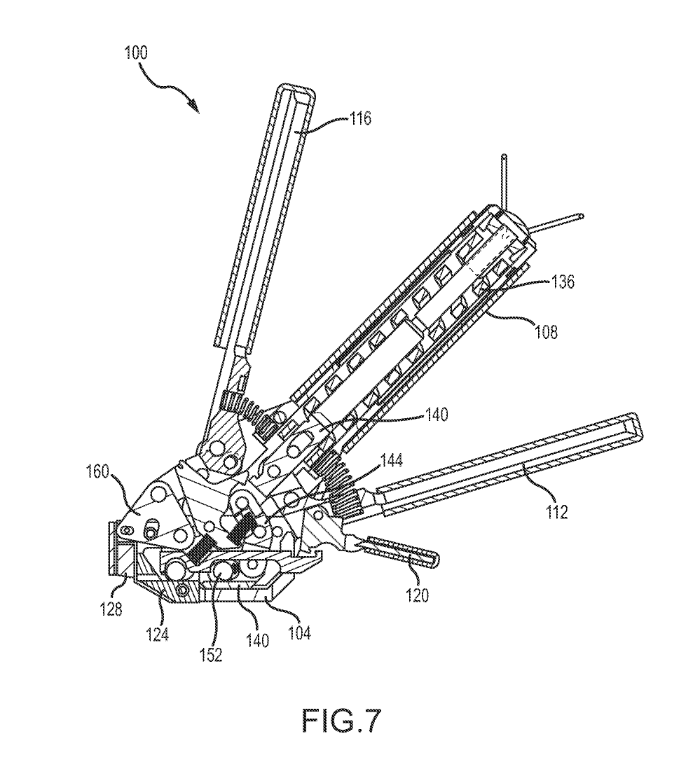

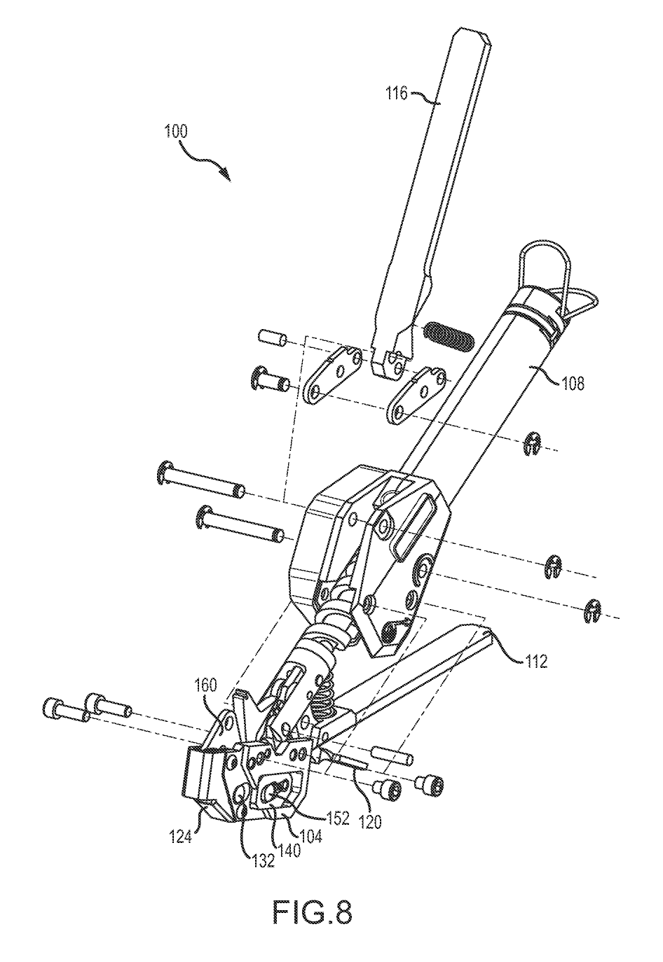

FIGS. 7 and 8 show the inner workings of one embodiment of the present invention. The handle 108 includes a spring 136 that is positioned about a rod 140. The rod 140 cooperates with a transfer lever 144 to dictate the amount of tension that can be applied to the band. In operation, the tension handle 112 is cycled toward and away from the handle 108 to move a tension block 148 and a gripper to tension the band 156. Again, the spring 136 position within the handle 108 will dictate the maximum tension that can be applied to the band as discussed in U.S. Pat. No. 5,566,726. Once the desired tension is achieved, the hook 120 is moved toward the handle 108 to lock the band at the desired tension. The cutoff handle 116 then is rotated towards the handle 108 which rotates the cutter arm 160 and moves the knife 128 downwardly to sever the band 156. Again, the mechanism contemplated by this embodiment of the present invention is similar to the Applicant's patents mentioned above.

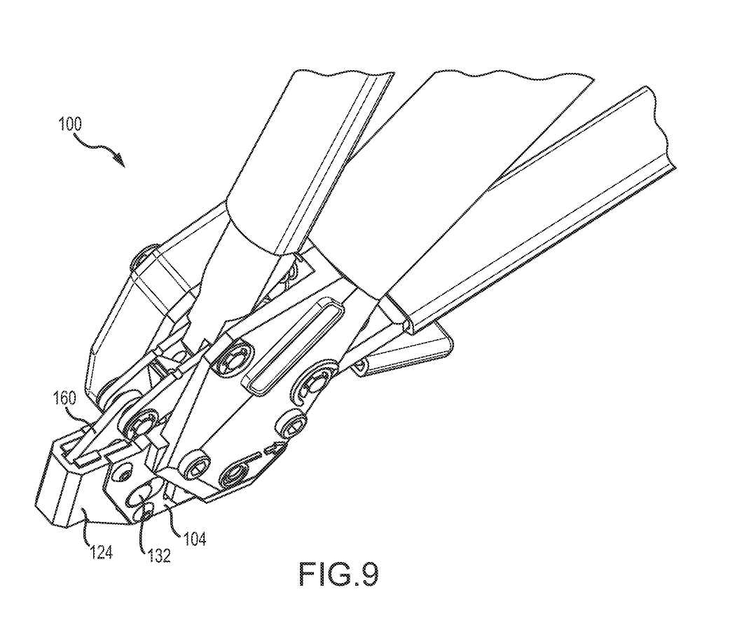

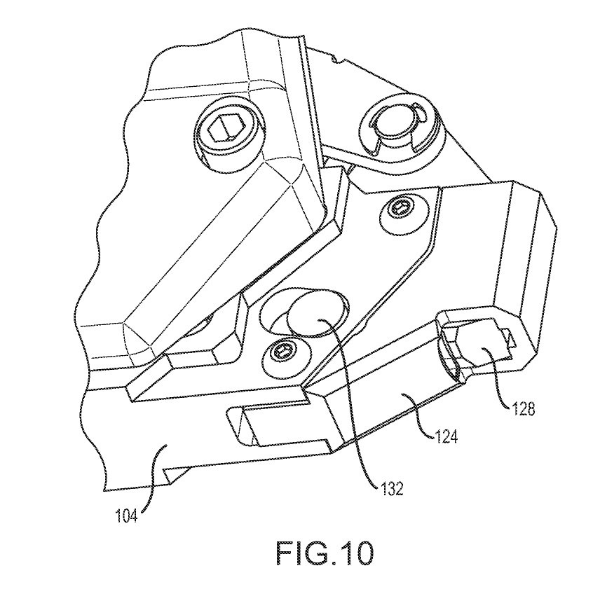

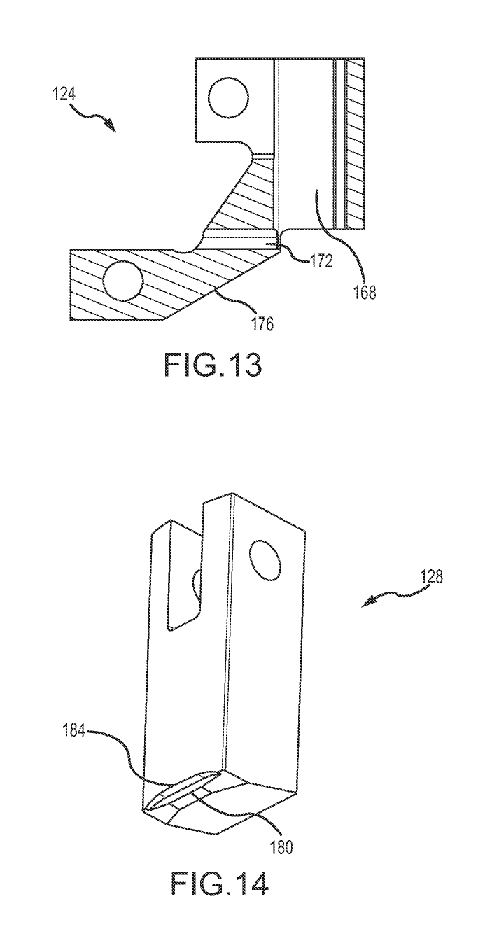

FIGS. 9-13 show the improved blade 124 and knife 128 of some embodiments of the present invention. More specifically, the blade of the prior art is replaced by a housing 164, that is statically interconnected to the head 104. The housing 16 includes the blade 124 with and integrated knife channel 168. The knife channel 168 may have a square profile that prevents significant rotation of the knife 128 within the knife channel 168. The blade 124 also includes a channel 172 for receipt of the band. As shown in FIG. 13, the band channel 168 is adapted to receive a band such that the blade edge is positioned beneath the band and a knife 128 is positioned above the band.

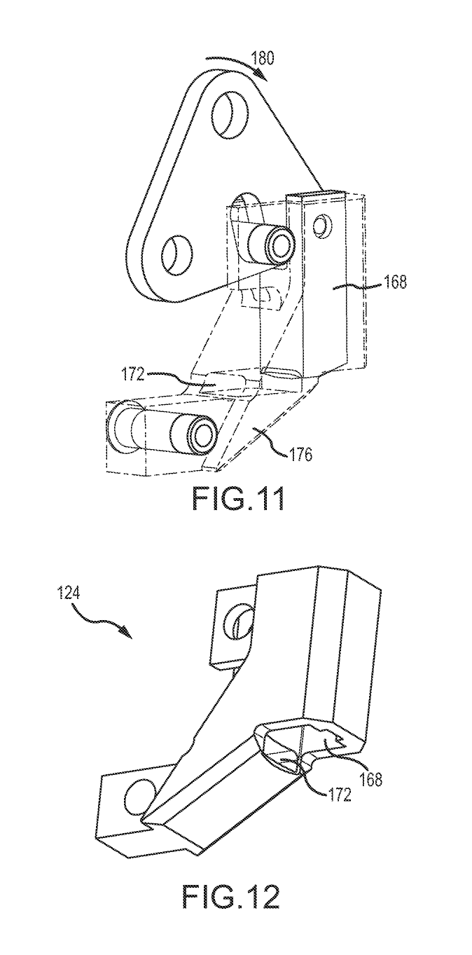

Referring to FIG. 11, in operation, when the cutoff handle 116 is actuated, the cutter arm 160 rotates along arrow 180, which moves the knife 128 downwardly along arrow 184 to sever the band. As described in detail below, this configuration maintains a tolerance between the blade edge and the knife 128 such that stainless steel bands can be severed.

FIG. 14 shows the knife 128 of one embodiment of the present invention that includes a cutting edge 180 and a deformation edge 184. That is, knife 128 may employs an arcuate cutting edge 180 and a cable tie head deformation edge 184. The cutting edge 180 initially contacts the band and is used with the blade to sever the band. Thereafter, the deformation edge 184 contacts the cable tie's locking feature, e.g., the cable tie head, and deforms the same.

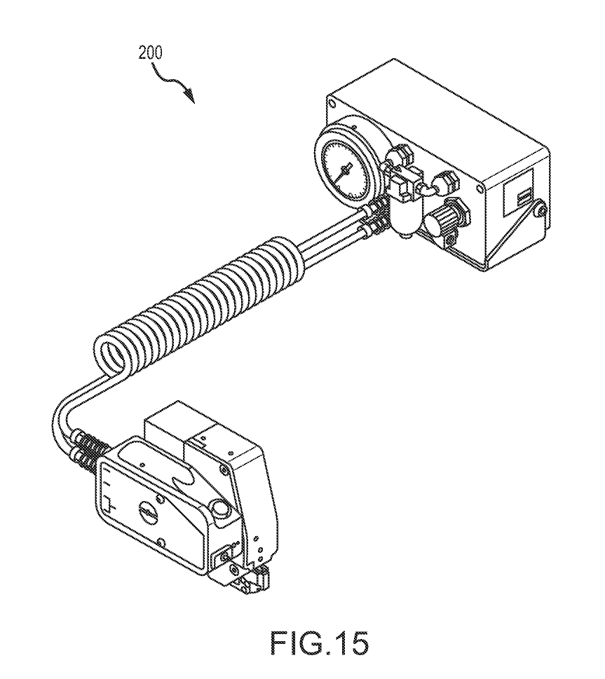

As one of ordinary skill will appreciate, the tool described herein can be made to operate pneumatically as shown in FIG. 15. More specifically, the tensioning arm and cutoff handle can replace by a pneumatic system 200 such that pneumatic forces are used to operate the tension block and other associated components described herein. Such systems are described in the Applicant's patent described above.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein is capable of other embodiments and of being practiced or of being carried out in various ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

What is claimed is:

1. A band cutting apparatus for a banding tool, comprising:
a knife;
a first channel for operative receipt of said knife, said knife capable of assuming a first position of use away from an open, distal end of said first channel, and a second position of use adjacent to said distal end of said first channel; and
a second channel adapted to receive a band, said second channel having a first opening near said distal end of said first channel, and a second opening spaced from said first opening, said first opening further comprising an edge that cooperates with said knife to sever a band positioned in said second channel and between said distal end of said first channel and said edge.

2. The apparatus of claim 1, wherein said first channel has an internal profile, comprising a first planar surface, a second planar surface, and a third planar surface, wherein the second and third planar surfaces are generally orthogonal to said first planar surface.

3. The apparatus of claim 2, wherein said knife has a first lateral surface and a second lateral surface that correspond with the second planar surface and the third planar surface of said first channel.

4. The apparatus of claim 1, wherein said first channel and second channel are orthogonal.

5. The apparatus of claim 1, wherein said knife includes a cutting edge, which cooperates with the blade edge to sever the band, and a band deformation edge spaced from said cutting edge, said band deformation edge adapted to contact a buckle associated with the band and deforms the same.

6. The apparatus of claim 1, wherein said knife is operatively interconnected to a cutter arm by way of a pin, wherein rotation of said cutter arm moves said knife from said first position of use to said second position of use.

7. The apparatus of claim 1, wherein said knife channel and said band channel are formed in the same homogenous piece of material.

8. The apparatus of claim 7, further comprising means for interconnecting to a head of the banding tool.

9. The apparatus of claim 1, wherein walls of said first channel substantially correspond with an outer profile of said knife.
